(19) United States
(12) Patent Application Publication
(10) Pub. No.: US 2014/0368395 A1
(43) Pub. Date: Dec. 18, 2014

(54) CROSSPOLAR MULTIBAND PANEL ANTENNA

(71) Applicant: ALCATEL LUCENT, Paris (FR)

(72) Inventors: Stephane Dauguet, Lannion (FR); Jean-Pierre Harel, Lannion (FR)

(73) Assignee: Alcatel Lucent, Boulogne Billancourt (FR)

(21) Appl. No.: 14/367,040

(22) PCT Filed: Dec. 20, 2012
(86) PCT No.: PCT/EP2012/076478

§ 371 Date: Jun. 19, 2014

(30) Foreign Application Priority Data
Dec. 23, 2011 (FR) 1162388

(51) Int. Cl. H01Q 21/26; H01Q 21/30

(52) U.S. Cl. CPC H01Q 21/26; H01Q 21/30
USPC 343/798

(57) ABSTRACT

The object of the present invention is a crosspolar multiband panel antenna comprising, within a single chassis, at least two antenna arrays operating within different frequency bands, each antenna array comprising at least two cross-polarization radiating elements separated by a distance inter-elements, each radiating element comprising a first polarization and a second polarization, the second polarization being orthogonal to the first polarization. The first polarization and the second polarization of each antenna array are physically separated by a distance equal to or greater than the distance inter-elements. The first polarizations and the second polarizations of each antenna array being respectively separated by one another by the distance inter-elements.

### CROSS-REFERENCE

This application is based on French Application No. 11,62,388 filed on Dec. 23, 2011, the disclosure of which is hereby incorporated by reference thereto in its entirety, and the priority of which is hereby claimed under 35 U.S.C. §119.

### BACKGROUND

This invention relates to the field of telecommunication antennas transmitting radio waves in the hyperfrequency range, using radiating elements. It particularly relates to antennas called crosspolar multiband panel antennas. A panel antenna is made up of multiple antenna arrays, such as patch antenna arrays or dipole arrays that work in a given frequency band, which are more particularly in a given frequency band that are more particularly intended for cellular telephony applications.

A telecommunication antenna, for example one installed in a base station of a mobile telephony network, sends and receives radio waves along frequencies specific to the telecommunication system operated by that antenna. To do so, the base station supplies each panel antenna with frequency waves within the frequency band that it operates, such as, for example, “Global System for Mobile communications” GSM (870-960 MHz), “Digital Cellular System” DCS (1710-1880 MHz), “Universal Mobile Telephone Service” UMTS (1900-2170 MHz), and LTE (for “Long Term Evolution”) for 700 MHz and 2600 MHz frequencies. In order to avoid increasing the number of antennas already installed, multi-band panel antennas are used that result from combining multiple series of radiating elements forming just as many antenna arrays, respectively belonging to separate telecommunication systems grouped into a single chassis formed of a shared reflector protected by a single radome.

Multiple configurations have been proposed to construct a crosspolar multiband panel antenna, made up of orthogonal-polarization antenna arrays operating in separate frequency bands, in which the radiating elements are inside the same chassis. A configuration called “side by side” comprising two parallel rows of radiating elements, placed at least a half-wavelength apart for the highest frequency band. Another configuration called “colinear” or “concentric”, in which the orthogonal-polarization radiating elements operating on a first frequency band are concentrically disposed, around orthogonal-polarization radiating elements operating on a second frequency band, all of those orthogonal-polarization radiating elements being aligned along a single axis. Yet another configuration consists of disposing alignments of radiating elements all in a line with one another. In order to reduce interactions between radiating elements operating within the same frequency band, unfed parasitic elements may be added.

All of these configurations aim to combine antenna arrays that operate in different frequency bands within a single chassis that has a fixed, limited volume, each antenna array having its own feed adapted to its own operating frequency band. This grouping is guided by considerations such as reducing the visual impact of the antennas, reducing the pylons' load, etc. However, within the increase in the number of frequency bands, and therefore in the number of antenna arrays within a single volume, such configurations lead to an increase in coupling between the radiating elements operating within each of those antenna arrays, which is a drawback in particular for MIMO applications and that requiring a diversity of signals.

In a crosspolar multiband panel antenna, the effectiveness in MIMO applications and that require a diversity of signals is related to decoupling between the polarizations of the radiating elements within each frequency band. The decoupling between the polarizations of the radiating elements is produced by the geometry of the radiating elements on the reflector shared by the antenna arrays, as well as by the presence of certain parasitic elements that make it possible to influence these coupling parameters. Assuming a crosspolar multiband panel antenna comprising a plurality of antenna arrays (at least 2, and up to 5 or even more) having separate operating frequency bands, each made up of aligned radiating elements placed under a single radome and carried by the same reflector, it is understood that these decoupling techniques become increasingly complicated to implement, because there is not enough physical space available within the chassis' overall volume to be able to maintain the same general form factor as traditional panel antennas that operate in at least two distinct frequency bands.

### SUMMARY

It is therefore a purpose of the present invention to improve decoupling between the two polarizations of the radiating elements of an antenna array operating within the same frequency band, without considerably increasing the size of a crosspolar multiband panel antenna, nor the weight or cost associated with it.

The object of the present invention is a crosspolar multiband panel antenna comprising, within a single chassis, at least two antenna arrays operating within different frequency bands, each antenna array comprising at least two cross-polarization radiating elements separated by a distance inter-elements, each radiating element comprising a first polarization and a second polarization, the second polarization being orthogonal to the first polarization, the first polarization and the second polarization belonging to the same radiating element are physically separated by a distance equal to or greater than the distance inter-elements.

The radiating element is defined by one row in the alignment forming the antenna array. A dual-polarization radiating element is, for example, formed of two independent dipoles, each with a given polarization. Here, “polarization” denotes both a dipole and a planar antenna, known as a “patch” antenna.

This is a new architecture of a crosspolar multiband panel antenna in which physical decoupling is combined with the traditionally used polarization decoupling, for each of the radiating elements, thereby allowing them to improve MIMO applications and applications that require diversity of signals.

The main idea of the invention is to not physically co-locate the two cross polarizations that correspond to a radiating element of the same row of an antenna array. This may be applied to some or all of the antenna arrays that form the multiband panel antenna (dual band, tri-band, four-band, etc.)

According to one aspect, the first polarizations that belong to one antenna array form a first alignment, and the second polarizations belonging to the same antenna array form a second alignment, the positions of the first and second polarizations belonging to the same radiating element being analogous within the first and second alignment, respectively.

According to another aspect, the first polarizations and the second polarizations of a single antenna array are separated by one another by a distance inter-elements within their respective alignments.

According to yet another aspect, the distance inter-elements within the first antenna array is equal to the distance inter-elements in the second antenna array.

According to one variant, a first polarization belonging to a first antenna array may be crossed with a second polarization belonging to a second antenna array.

According to another variant, a polarization belonging to an antenna array may be crossed with a parasitic element.

According to one embodiment, all of the first polarizations belonging to one antenna array and all of the second polarizations belonging to the same antenna array are disposed with respect to one another in such a way as to increase the distance separating the first polarization from the second polarization of a single radiating element.

According to another embodiment, the polarizations are disposed in such a way as to occupy all the available space within the panel antenna's chassis.

One advantage of the invention is to improve decoupling between the cross-polarization radiating elements of the antenna arrays composing a multiband panel antenna combining the spatial decoupling with the polarization decoupling for each radiating element in order to get better results for signal diversity algorithms and MIMO. It also makes it possible to simplify the design and overall internal structure of the crosspolar multiband panel antenna, without increasing the dimensions of the chassis, all while offering additional decoupling between the two polarizations owing to the distance physically separating them. It thereby makes it possible to increase decoupling between the polarizations for each frequency band (improved by 5-10 dB).

The invention applies to any type of crosspolar multiband panel antenna made up of antenna arrays, regardless of the polarization angle. The invention may also be used without any limitation in the number of antenna arrays, i.e. the number of frequency bands in question.

### BRIEF DESCRIPTION

Other characteristics and advantages of the present invention will become apparent upon reading the following description of one embodiment, which is naturally given by way of a non-limiting example, and in the attached drawing, in which:

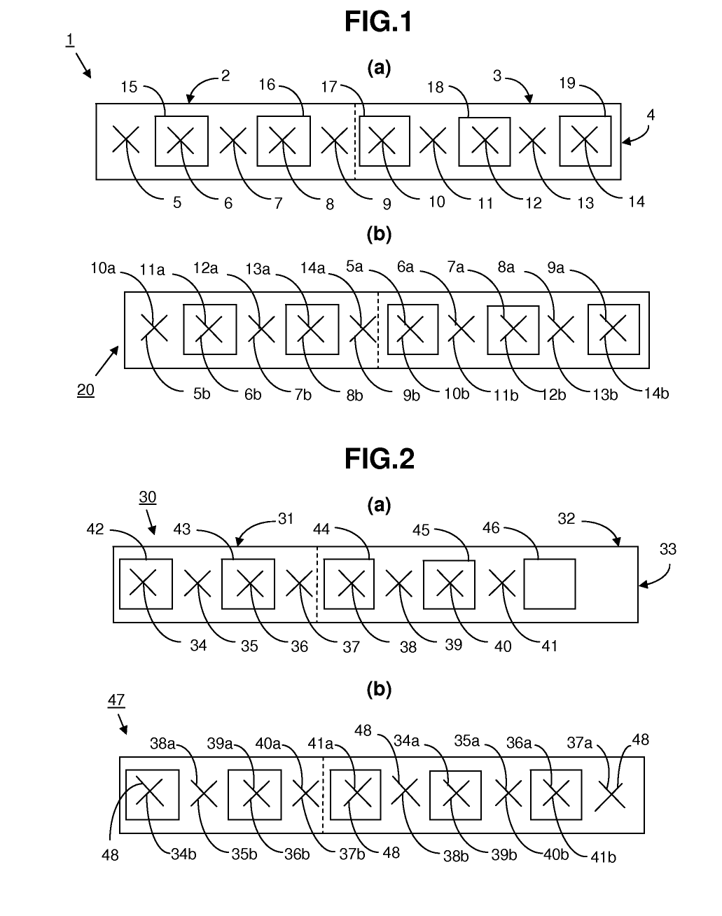

FIGS. 1a and 1b depict a first embodiment of a tri-band array,

FIGS. 2a and 2b depict a second embodiment of a tri-band array,

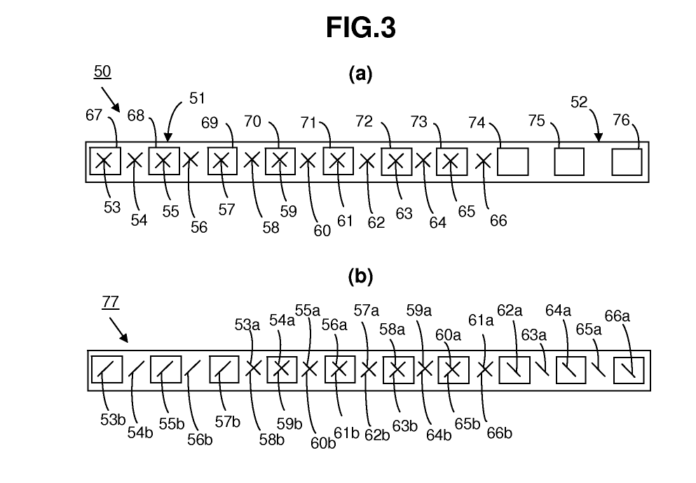

FIGS. 3a and 3b depict an embodiment of a dual-band array,

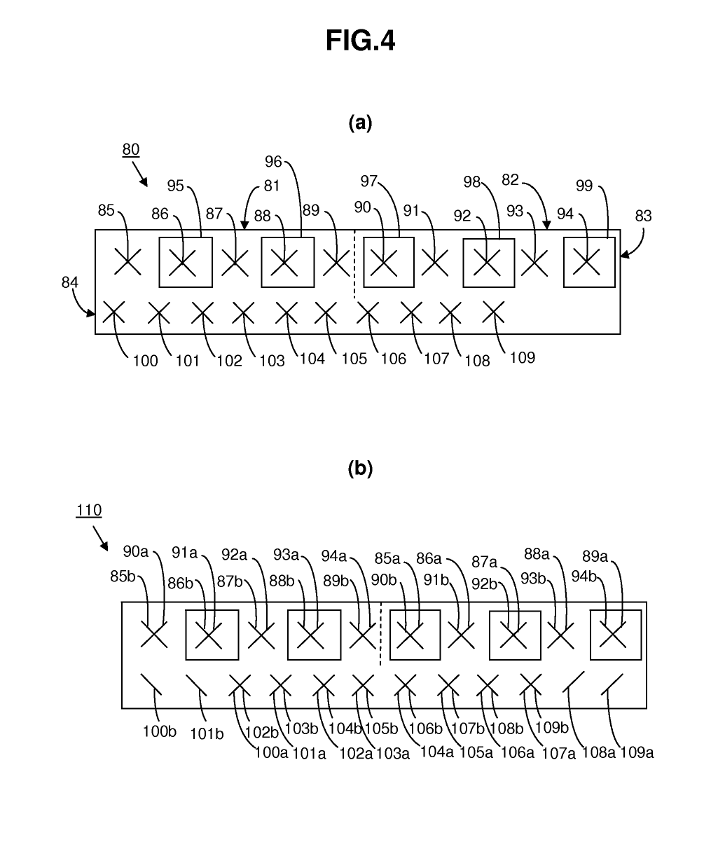

FIGS. 4a and 4b depict an embodiment of a four-band array,

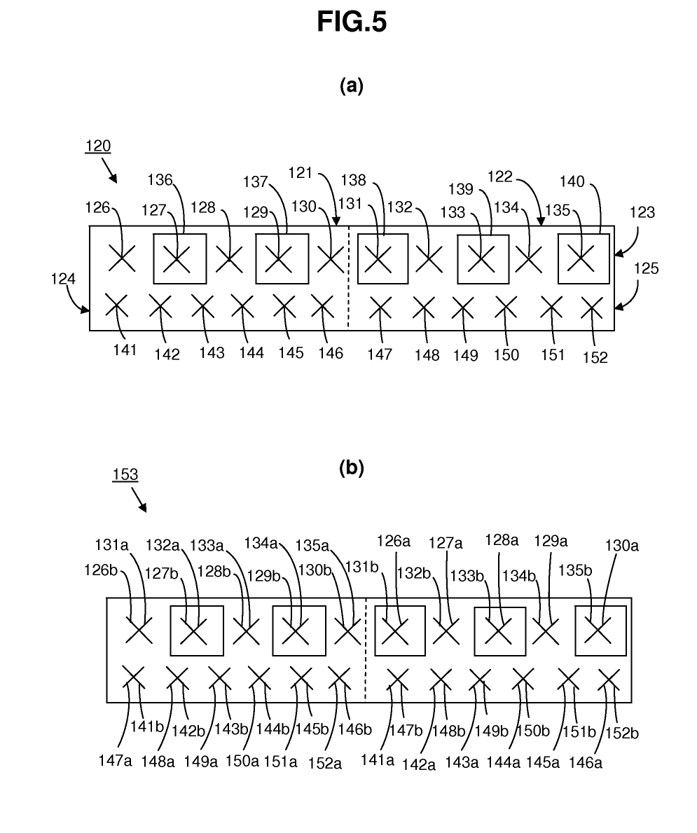

FIGS. 5a and 5b depict an embodiment of a five-band array.

### DETAILED DESCRIPTION

The radiating elements of a single antenna array are devoted to sending/receiving on a single frequency band. A dual-polarization radiating element is normally formed of two independent dipoles each comprising two colinear conductor arms with a given polarization, positive or negative, for sending/receiving radio signals. What will be described for each polarization, represented here by a dipole, also applies when the polarization is represented by a planar antenna or “patch” antenna. The radiating elements are installed longitudinally aligned above a reflector. Depending on their orientation within space, the dipoles may radiate or receive electromagnetic waves along two polarization channels, for example, a horizontal polarization channel, and a vertical polarization channel, or two polarization channels oriented +45° and −45° relative to the vertical. Each dipole of a radiating element is linked by a feed line to an outside source of power that defines its phase and amplitude

In the known configuration depicted in FIG. 1a, a tri-band cross-polarization panel antenna 1 comprises a first antenna array 2 operating in a high frequency band Fa-Fb, a second antenna array 3 operating in another high frequency band Fc-Fd and a third antenna array 4 operating in a low frequency band Fe-Ff. The first antenna array 2 comprises an alignment of five radiating elements 5, 6, 7, 8, 9 with two crossed polarizations oriented +45° and −45° relative to the axis of the first antenna array 2. The second antenna array 3 comprises, along the length of the first antenna array 2, an alignment of five radiating elements 10, 11, 12, 13, 14 with two cross polarizations oriented +45° and −45° relative to the axis of the second antenna array 3. Finally, the third antenna array 4 comprises an alignment of five radiating elements 15, 16, 17, 18, 19 concentrically disposed around certain radiating elements 6, 8, 10, 12, 14 belonging to the first antenna array 2 and to the second antenna array 3.

A first mode embodiment of a tri-band panel antenna 20 is depicted in FIG. 1b. The dipoles 5a, 6a, 7a, 8a, 9a with polarity −45°, of the radiating elements 5, 6, 7, 8, 9 of the first antenna array 2 are moved towards the opposite end of the tri-band panel antenna 20 by a distance that here corresponds to five times the distance inter-elements, without their relative positioning being altered. However, the position of the dipoles 5b, 6b, 7b, 8b, 9b with polarity +45° of the radiating elements 5, 6, 7, 8, 9 of the first antenna array 2 remain unchanged. In the reverse direction, the dipoles 10a, 11a, 12a, 13a, 14a with polarity −45° of the radiating elements 10, 11, 12, 13, 14 of the second antenna array 3 are now moved towards the other end of the tri-band panel antenna 20 by a distance that here corresponds to five times the distance inter-elements, without their relative positioning being altered. However, the position of the dipoles 10b, 11b, 12b, 13b, 14b with polarity +45° of the radiating elements 10, 11, 12, 13, 14 of the second antenna array 3 remain unchanged. In order for these movements to be possible, the distance inter-elements in the first antenna array 2 is the same as the distance inter-elements in the second antenna array 3.

The purpose of these movements is to obtain the maximum physical distance between the two polarizations of each radiating element of the first antenna array 2 and of the second antenna array 3. The radiating elements 15, 16, 17, 18, 19 of the third antenna array 4 are not moved. The first polarizations 5a, 6a, 7a, 8a, 9a belonging to the first antenna array 2 are therefore crossed with the second polarizations 10b, 11b, 12b, 13b, 14b belonging to the second antenna array 3. Likewise, the first polarizations 10a, 11a, 12a, 13a, 14a belonging to the second antenna array 3 are therefore crossed with the second polarizations 5b, 6b, 7b, 8b, 9b belonging to the first antenna array 2

From a practical viewpoint, these dipole movements consist of altering the branching of the feed lines connected to each of the dipoles to be moved. It is understood that the movement of the dipoles with polarity −45° that has just been described could also have been described for polarity +45°, in which case the positions of the dipoles with polarity −45° would remain unchanged.

FIG. 2a depicts another known configuration of a tri-band panel antenna 30 comprising a first antenna array 31 operating within a high-frequency band Fa-Fb, a second antenna array 32 operating within another high-frequency band Fc-Fd and a third antenna array 33 operating within a low-frequency band Fe-Ff. The first antenna array 31 comprises an alignment of four radiating elements 34, 35, 36, 37 with two cross polarizations oriented +45° and −45° relative to the axis of the first antenna array 31. The second antenna array 32 comprises, along the length of the first antenna array 31, an alignment of four radiating elements 38, 39, 40, 41 with two cross polarizations oriented +45° and −45° relative to the axis of the second antenna array 32. Finally, the third antenna array 33 comprises an alignment of five radiating elements 42, 43, 44, 45, 46, four radiating elements 42, 43, 44, 45 of the third antenna array 33 are concentrically disposed around radiating elements 34, 36, 38, 40 belonging to the first antenna array 31 and to the second antenna array 32. In the chassis of the tri-band panel antenna 30, two positions are unoccupied: one placed at the center of the radiating element 46 of the third antenna array 33 and the other that is contiguous with it.

A second mode embodiment of a tri-band panel antenna 47 is depicted in FIG. 2b. The dipoles 34a, 35a, 36a, 37a with polarity −45° of the radiating elements 34, 35, 36, 37 of the first antenna array 31 are moved towards the opposite end of the tri-band panel antenna 47 by a distance that here corresponds to six times the distance inter-elements, without their relative positioning being altered. However, the positions of the dipoles 34b, 35b, 36b, 37b with polarity +45° of the radiating elements 34, 35, 36, 37 of the first antenna array 31 remain unchanged The dipoles 38a, 39a, 40a, 41a with polarity −45° of the radiating elements 38, 39, 40, 41 of the second antenna array 32 are now moved in the reverse direction, towards the other end of the tri-band panel antenna 47 by a distance that here corresponds to three times the distance inter-elements, without their relative positioning being altered. However, the dipoles 38b, 39b, 40b, 41b with polarity +45° of the radiating elements 38, 39, 40, 41 of the second antenna array 32 were shifted by the distance inter-elements in the same direction as the dipoles 34a, 35a, 36a, 37a belonging to the first antenna array 31, so as to occupy the free positions, without their relative positioning being altered. The purpose of these movements is to obtain the maximum physical distance between the two polarizations of each radiating element of the first antenna array 31 and the second antenna array 32 by occupying all the available space. The radiating elements 42, 43, 44, 45, 46 of the third antenna array 33 are not moved. Naturally, these movements may only be performed provided that the distance inter-elements within the first antenna array 31 is the same as the distance inter-elements in the second antenna array 32.

Parasitic elements are often added to the antenna arrays in order to improving the decoupling between the radiating elements. Here, the term parasitic element refers to a conductive element which is not fed, neither directly, nor indirectly, by way of the dipole. It is often designated by the term “director”. The physical distance between the dipoles of a single radiating element makes it possible to reduce the needed number of parasitic elements. The free positions adjacent to the dipoles 34b, 41a 38b, 37a may be occupied by unfed parasitic elements 48. In such a case, the polarizations 34b, 41a 38b, 37a belonging to the first antenna array 31 and to the second antenna array 32 are crossed with a parasitic element.

FIG. 3a depicts a dual-band panel antenna 50 in a known configuration. The dual-band panel antenna 50 comprises a first antenna array 51 operating within a high-frequency band Fc-Fd and a second antenna array 52 operating within a low-frequency band Fe-Ff. The first antenna array 51 comprises an alignment of fourteen radiating elements 53-66 with two cross polarizations oriented +45° and −45° relative to the axis of the first antenna array 51. The second antenna array 52 comprises, coaxially with the first antenna array 51, an alignment of ten radiating elements 67-76, the radiating elements 67, 68, 69, 70, 71, 72, 73 of the second antenna array 52 being concentrically disposed around certain radiating elements 53, 55, 57, 59, 61, 63, 65 belonging to the first antenna array 51. In the chassis of the dual-band panel antenna 50, multiple positions are unoccupied: some placed at the center of the radiating elements 74, 75, 76 of the second antenna array 52 and the others placed between the radiating elements 74 and 75 and between the radiating elements 75 and 76.

One embodiment of a dual-band panel antenna 77 is depicted in FIG. 3b. The dipoles 53a-66a with polarity −45° of the radiating elements 53-66 of the first antenna array 51 are moved towards the opposite end of the dual-band panel antenna 77 by a distance here equal to five times the distance inter-elements so as to occupy the free positions, without their relative positioning being altered. However, the positions of the dipoles 53b-66b with polarity +45° of the radiating elements 53-66 of the first antenna array 51 remain unchanged The radiating elements 67-76 of the second antenna array 52 are not moved. This embodiment leads to a high total level of decoupling between the two polarizations. This is the same as with the tri-band panel antenna 47. The free positions adjacent to the dipoles 53b, 54b, 55b, 56b, 57b, 62a, 63a, 64a, 65a, 66a may be occupied by unfed parasitic elements. The polarities 53b, 54b, 55b, 56b, 57b, 62a, 63a, 64a, 65a, 66a are then crossed with parasitic elements

In a known configuration depicted in FIG. 4a, a four-band panel antenna 80 comprises a first antenna array 81 operating within a high-frequency band Fa-Fb, a second antenna array 82 operating within another high-frequency band Fc-Fd, a third antenna array 83 operating within a low-frequency band Fe-Ff and a fourth antenna array 84 operating within a high-frequency band Fg-Fh. The first antenna array 81 comprises an alignment of five radiating elements 85, 86, 87, 88, 89 with two cross polarizations oriented +45° and −45° relative to the axis of the first antenna array 81. The second antenna array 82 comprises, along the length of the first antenna array 81, an alignment of five radiating elements 90, 91, 92, 93, 94 with two cross polarizations oriented +45° and −45° relative to the axis of the second antenna array 82. The third antenna array 83 comprises an alignment of five radiating elements 95, 96, 97, 98, 99 concentrically disposed around certain radiating elements 86, 88, 90, 92, 94 belonging to the first antenna array 81 and to the second antenna array 82. Finally, the fourth antenna array 84 comprises, in parallel with the three other antenna arrays 81, 82, 83, an alignment of ten radiating elements 100-109 with two cross polarizations oriented +45° and −45° relative to the axis of the fourth antenna array 84:

One embodiment of a four-band panel antenna 110 is depicted in FIG. 4b. The dipoles 85a, 86a, 87a, 88a, 89a with polarity −45°, of the radiating elements 85, 86, 87, 88, 89 of the first antenna array 81 are moved towards the opposite end of the four-band panel antenna 110 by a distance that here corresponds to five times the distance inter-elements, without their relative positioning being altered. However, the positions of the dipoles 85b, 86b, 87b, 88b, 89b with polarity +45° of the radiating elements 85, 86, 87, 88, 89 of the first antenna array 81 remain unchanged. In the reverse direction, the dipoles 90a, 91a, 92a, 93a, 94a with polarity −45° of the radiating elements 90, 91, 92, 93, 94 of the second antenna array 82 are now moved towards the other end of the tri-band panel antenna 110 by a distance that here corresponds to five times the distance inter-elements, without their relative positioning being altered. However, the positions of the dipoles 90b, 91b, 92b, 93b, 94b with polarity +45° of the radiating elements 90, 91, 92, 93, 94 of the second antenna array 82 remain unchanged. The radiating elements 95, 96, 97, 98, 99 of the third antenna array 83 are not moved. The distance inter-elements in the first antenna array 81 is the same as the distance inter-elements in the second antenna array 82.

The dipoles 100a, 101a, 102a, 103a, 104a, 105a, 106a, 107a, 108a, 109a with polarity −45° of the radiating elements 100-109 of the fourth antenna array 84 are now moved in a parallel orientation and in the same direction as the movement of the dipoles 85a, 86a, 87a, 88a, 89a of the radiating elements 85, 86, 87, 88, 89 of the first antenna array 81, by a distance that here corresponds to twice the distance inter-elements, without their relative positioning being altered. As before, the positions of the dipoles 100b, 101b, 102b, 103b, 104b, 105b, 106b, 107b, 108b, 109b with polarity +45° of the radiating elements 100-109 of the fourth antenna array 84 remain unchanged In this case, the polarities 100b, 101b, 108a, 109a may be crossed with parasitic elements.

FIG. 5a depicts a five-band panel antenna 120 in a known configuration. The five-band panel antenna 120 comprises a first antenna array 121 operating within a high-frequency band Fa-Fb, a second antenna array 122 operating within another high-frequency band Fc-Fd, a third antenna array 123 operating within a low-frequency band Fe-Ff, a fourth antenna array 124 operating within a high-frequency band Fg-Fh, and a fifth antenna array 125 operating within a high-frequency band Fi-Fj. The first antenna array 121 comprises an alignment of five radiating elements 126, 127, 128, 129, 130 with two crossed polarizations oriented +45° and −45° relative to the axis of the first antenna array 121. The second antenna array 122 comprises, along the length of the first antenna array 121, an alignment of five radiating elements 131, 132, 133, 134, 135 with two cross polarizations oriented +45° and −45° relative to the axis of the second antenna array 122. The third antenna array 123 comprises an alignment of five radiating elements 136, 137, 138, 139, 140 concentrically disposed around certain radiating elements 127, 129, 131, 133, 135 belonging to the first antenna array 121 and to the second antenna array 122. The fourth antenna array 124 comprises, parallel to the first three antenna arrays 121, 122, 123, an alignment of six radiating elements 141, 142, 143, 144, 145, 146 with two cross polarizations oriented +45° and −45° relative to the axis of the fourth antenna array 124. Finally, the fifth antenna array 125 comprises, along the length of the fourth antenna array 124 and parallel to the first three antenna arrays 121, 122, 123, an alignment of six radiating elements 147, 148, 149, 150, 151, 152 with two cross polarizations oriented +45° and −45° relative to the axis of the fifth antenna 125.

One embodiment of a five-band panel antenna 153 is depicted in FIG. 5b. The dipoles 126a, 127a, 128a, 129a, 130a with polarity −45°, of the radiating elements 126, 127, 128, 129, 130 of the first antenna array 121 are moved towards the opposite end of the five-band panel antenna 153 by a distance that here corresponds to five times the distance inter-elements, without their relative positioning being altered. However, the positions of the dipoles 126b, 127b, 128b, 129b, 130b with polarity +45° of the radiating elements 126, 127, 128, 129, 130 of the first antenna array 121 remain unchanged. The dipoles 131a, 132a, 133a, 134a, 135a with polarity −45° of the radiating elements 131, 132, 133, 134, 135 of the second antenna array 122 are now moved towards the other end of the five-band panel antenna 153 by a distance that here corresponds to five times the distance inter-elements, without their relative positioning being altered. However, the positions of the dipoles 131b, 132b, 133b, 134b, 135b with polarity +45° of the radiating elements 131, 132, 133, 134, 135 of the second antenna array 122 remain unchanged. The radiating elements 136, 137, 138, 139, 140 of the third antenna array 123 are not moved. The distance inter-elements in the first antenna array 121 is the same as the distance inter-elements in the second antenna array 122.

Furthermore, the dipoles 141a, 142a, 143a, 144a, 145a, 146a with polarity −45° of the radiating elements 141, 142, 143, 144, 145, 146 of the fourth antenna array 124 are now moved in a parallel orientation and in the same direction as the movement of the dipoles 126a, 127a, 128a, 129a, 130a of the radiating elements 126, 127, 128, 129, 130 of the first antenna array 121, by a distance that here corresponds to six times the distance inter-elements, without their relative positioning being altered. The positions of the dipoles 141b, 142b, 143b, 144b, 145b, 146b with polarity +45° of the radiating elements 141, 142, 143, 144, 145, 146 of the fourth antenna array 124 remain unchanged Finally, the dipoles 147a, 148a, 149a, 150a, 151a, 152a with polarity −45° of the radiating elements 147, 148, 149, 150, 151, 152 of the fifth antenna array 125 now moved in a parallel orientation and in the same direction as the movement of the dipoles 131a, 132a, 133a, 134a, 135a of the radiating elements 131, 132, 133, 134, 135 of the second antenna array 122, by a distance that here corresponds to six times the distance inter-elements, without their relative positioning being altered. The positions of dipoles 147b, 148b, 149b, 150b, 151b, 152b with polarity +45° of the radiating elements 147, 148, 149, 150, 151, 152 of the fifth antenna array 125 remain unchanged The distance inter-elements in the fourth antenna array 124 is the same as the distance inter-elements in the second antenna array 125. This distance inter-elements may be equal to or different from the first 121 and second 122 antenna arrays.

Naturally, the present invention is not limited to the described embodiments, but is, rather, subject to many variants accessible to the person skilled in the art without departing from the spirit of the invention. In particular, what has previously been described for dipoles applies just as well to a planar antenna, known as a patch antenna.

1. A crosspolar multiband panel antenna, comprising within a single chassis, at least one first antenna array and a second antenna array operating within different frequency bands, each antenna array comprising at least two cross-polarization radiating elements separated by a distance inter-elements, each radiating element comprising a first polarization and a second polarization, the second polarization being orthogonal to the first polarization, characterized in that the first polarization and the second polarization belonging to the same radiating element are physically separated by a distance equal to or greater than the distance inter-elements.

2. A panel antenna according to claim 1, wherein the first polarizations that belong to one antenna array form a first alignment, and the second polarizations belonging to the same antenna array form a second alignment, the positions of the first and second polarizations belonging to the same radiating element being analogous within the first and second alignment, respectively.

3. A panel antenna according to claim 2, the first polarizations and the second polarizations of a single antenna array are separated by one another by a distance inter-elements within their respective alignments.

4. A panel antenna according to claim 1, wherein the distance inter-elements in the first antenna array is equal to the distance inter-elements in the second antenna array.

5. Antennas according to claim 1, wherein a first polarization belonging to a first antenna array may be crossed with a second polarization belonging to a second antenna array.

6. Antennas according to claim 1, wherein a polarization belonging to an antenna array may be crossed with a parasitic element.

7. A panel antenna according to claim 1, wherein all of the first polarizations belonging to one antenna array and all of the second polarizations belonging to the same antenna array are disposed with respect to one another in such a way as to increase the distance separating the first polarization from the second polarization of a single radiating element.

8. Antennas according to claim 1, wherein the polarizations are disposed in such a way as to occupy all the available space within the panel antenna's chassis.
